(19) United States
(12) Patent Application Publication
(10) Pub. No.: US 2012/0281114 A1
(43) Pub. Date: Nov. 8, 2012

(54) SYSTEM, METHOD AND APPARATUS FOR PROVIDING AN ADAPTIVE MEDIA EXPERIENCE

(75) Inventors: Jeffrey Michael Shapiro, New York, NY (US); Jack Maley, New York, NY (US); Paul Rosenfeld, Belmont, CA (US); Roger Nelson, Emeryville, CA (US)

(73) Assignee: IVI MEDIA LLC, New York, NY (US)

(21) Appl. No.: 13/463,409

(22) Filed: May 3, 2012

Related U.S. Application Data
(60) Provisional application No. 61/482,117, filed on May 3, 2011.

(51) Int. Cl. H04N 5/262; H04N 5/76; H04N 5/222

(52) U.S. Cl. 348/231.99; 348/239; 348/333.01; 348/E05.053; 348/E05.022; 348/E05.024

(57) ABSTRACT

A system, method, and apparatus for providing an adaptive interactive media experience are described. Aspects of the invention provide instruction for an actor performing in a virtual studio. The actor and a video capture device are directed using one or more specified video templates. The templates may be associated with a particular clip, such that the actor is inserted into the particular clip upon completion of the performance. Additional aspects of the invention provide for an adaptive media device for capturing the video and providing instructions, and a method for generating one or more templates.

### CROSS REFERENCE TO RELATED APPLICATION

This application claims the benefit of the filing date of U.S. Provisional Patent Application No. 61/482,117 filed on May 3, 2011, the disclosure of which is hereby incorporated herein by reference.

### BACKGROUND

Advances in digital video capture and editing technology have made the art of video editing more efficient and less expensive. Media studios of all types are leveraging numerous technologies in the creation of virtual studios featuring the use of green or blue backgrounds that can be color-keyed out to support the insertion or layering of actors, props, sets and existing media to assemble artistically desirable combinations. The resulting work product is virtually unlimited in potential scope and application to the generation of film and video scenes.

However, although video capture technology has advanced, actors performing in such virtual studios still require careful direction to create a composite scene that appears believable. Such virtual studios may lack visual or audible reference points for the actors during their performance. If a scene requires an actor to look at a certain virtual object, it may be difficult for the performer to determine exactly where the virtual object is located in relation to their position. If the scene requires the actor to react to a loud noise that will later be edited in, it may be difficult to properly time the reaction.

### BRIEF SUMMARY

A system, method, and apparatus for providing an adaptive interactive media experience are described. Aspects of the invention allow for adaptive prompting and recording of actors to optimize media capture operations.

Aspects of the disclosure describe a computer-implemented method for providing an adaptive media experience to a user. The method may include providing a video template, operating an adaptive media device to display information to the user on a display in accordance with the video template. The display may be located at a first location specified in the video template such that the user is positioned in a first desired position. The method may further include further operating the adaptive media device to position the display at a second location such that the user is positioned in a second desired position, operating a video capture element to capture video of the user at at least one of the first desired position or the second desired position, integrating the captured video into at least a portion of a preexisting video to create a composite video. The information may comprise at least one of a script line or a stage direction to instruct the user. The display may be positioned using a robotic arm. The preexisting video may be associated with the video template. The method may include projecting a position cue to notify the user to stand in at least one of the first desired position or the second desired position. The method may also include configuring the video capture element using the video template. The configuration of the video capture element may include at least one of a pan, tilt, or zoom setting of the video capture element or adjusting a focus setting of the video capture element. The positioning the user at the first desired position may include displaying the information in a physical location to direct the user to look in the first desired position. The video template may include timing instructions and control instructions keyed to the timing instructions. The adaptive media device may be positioned using the control instructions in accordance with the timing instructions.

Aspects of the disclosure may provide an adaptive media device. The adaptive media device may include a display element for displaying information to a user of the adaptive media device. The display element may be movable to at least two locations in accordance with a video template, such that the at least two locations direct a position of the user during a video capture operation. The adaptive media device may further include a video capture element for performing the video capture operation. The adaptive media device may further include a positioning element for moving the display element in accordance with the video template. The positioning element may be a robotic arm and wherein the video template comprises instructions for moving the robotic arm. The adaptive media device may also include a location cue element for indicating a position of an actor in accordance with the video template. The location cue element may include a projector. The location cue element may indicate the position of the actor by projecting an image at the position. The display element may be moved to one of the at least two locations and the information may be displayed such that the user is looking in a particular direction. The information may be at least one of a script line or a stage direction. The display element may be configured such that the one or more script lines or direction prompts are only visible when the actor is standing at the position indicated by the location cue element. The video template may include timing instructions and control instructions keyed to the timing instructions. The display element may be positioned using the control instructions at one or more times indicated by the timing instructions. The control instructions may include one or more location cues and one or more camera configuration instructions.

Aspects of the disclosure may also provide a video system for providing a composite video. The video system may include a memory for storing a video template. The video template may include one or more instructions for displaying information to a user. The video system may further include an adaptive media device for displaying information to a user of the system in accordance with the video template. The adaptive media device may be movable to at least two locations in accordance to the video template. The at least two locations may direct the user to at least one of a first position or a second position, respectively. The video system may further include a video capture element for capturing video of the user at at least one of the first position or the second position.

### BRIEF DESCRIPTION OF THE DRAWINGS

FIG. 1 illustrates a system diagram of an adaptive media capture system in accordance with aspects of the invention.

FIG. 2 illustrates a display for providing instruction via an adaptive media device in accordance with aspects of the invention.

FIG. 3 illustrates the operation of a system for indicating a placement cue using an adaptive media device in accordance with aspects of the invention.

FIG. 4 illustrates a method for providing an adaptive interactive media experience in accordance with aspects of the invention.

FIG. 5 illustrates a method for generating a video template for use in an adaptive interactive media system in accordance with aspects of the invention.

FIG. 6 illustrates a studio workflow in accordance with aspects of the invention.

### DETAILED DESCRIPTION

A system, method, and apparatus for providing an adaptive interactive media experience are described. Aspects of the invention provide instruction for an actor performing in a virtual studio. The actor and a video capture device are directed using one or more specified video templates. The templates may be associated with a particular clip, such that the actor is inserted into the particular clip upon completion of the performance. Additional aspects of the invention provide for an adaptive media device for capturing the video and providing instructions, and a method for generating one or more templates.

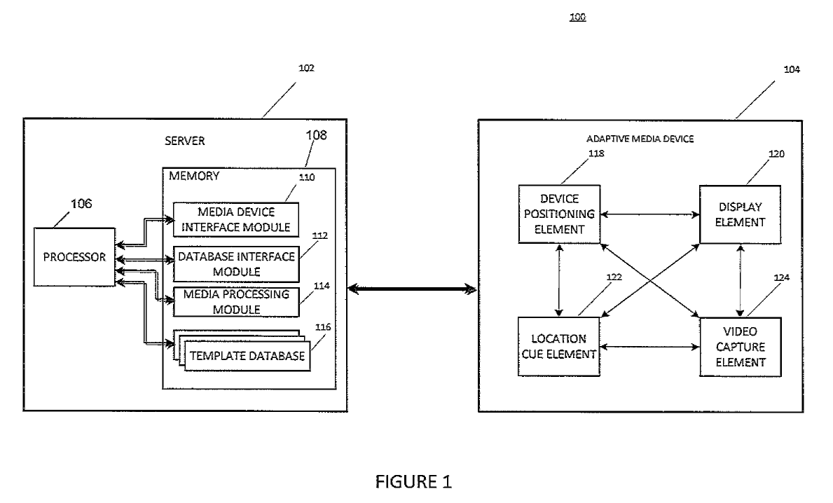

FIG. 1 illustrates a system diagram of an adaptive media capture system 100 in accordance with aspects of the invention. As shown in FIG. 1, a system 100 in accordance with one aspect of the invention includes a server 102 and an adaptive media device 104. The server 102 operates to control the adaptive media device 104 to facilitate the video capture operations of the adaptive media system 100. The adaptive media device 104 comprises various positioning, prompting, and recording elements that, when controlled by the server 102, operate to provide an adaptive media experience. Although the server 102 and the adaptive media device 104 are described herein as separate elements in communication with one another, such a system could also be implemented as a single device having characteristics of both the server 102 and the adaptive media device 104.

The server 102 may include a processor 106, a memory 108 and other components typically present in general purpose computers. The memory 108 may store instructions and data that are accessible by the processor 106. The processor 106 may execute the instructions and access the data to control the operations of the server 102 and/or the operations of the adaptive media device 104.

The memory 108 may be any type of memory operative to store information accessible by the processor 106, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

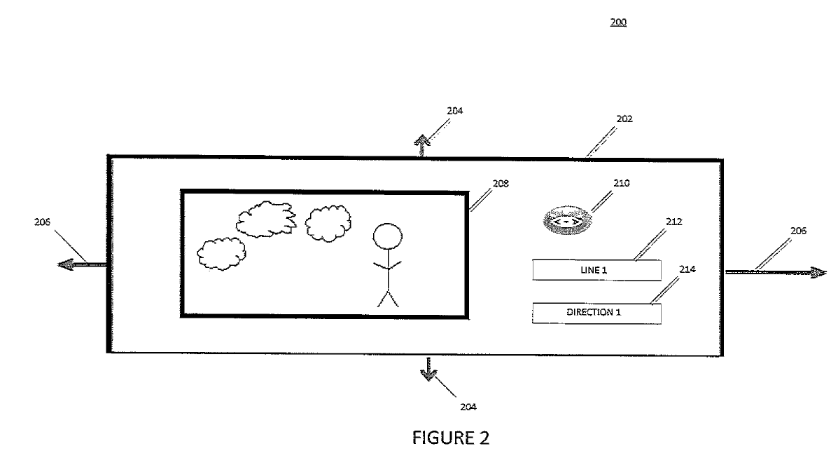

The instructions may be any set of instructions to be executed directly (such as machine code) or indirectly (such as scripts) by the processor 106. For example, the instructions may be stored as computer code on a tangible computer-readable medium. In that regard, the terms “instructions” and “programs” may be used interchangeably herein. The instructions may be stored in object code format for direct processing by the processor 106, or in any other computer language including scripts or collections of independent source code modules that are interpreted on demand or compiled in advance. Functions, methods, and routines of the instructions are explained in more detail below (see FIGS. 2-5).

Data may be retrieved, stored or modified by processor in accordance with the instructions. For instance, although the architecture is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 106 may be any well-known processor, such as processors from Intel Corporation or AMD. Alternatively, the processor may be a dedicated controller such as an application-specific integrated circuit (ASIC). Although FIG. 1 functionally illustrates the processor and memory as each being within a single block, it should be understood that the processor 106 and memory 108 may actually comprise multiple processors and memories that may or may not be stored within the same physical housing. Accordingly, references to a processor, computer, or memory will be understood to include references to a collection of processors, computers, or memories that may or may not operate in parallel.

The server 102 may be at one node of a network and be operative to directly and indirectly communicate with other nodes of the network. For example, the server 102 may comprise a web server that is operative to communicate with a adaptive media device 104 via a network such that the server 102 uses the network to transmit and display information to the adaptive media device 104. While the concepts described herein are generally discussed with respect to a server 102, aspects of the invention may be applied to any computing node capable of managing adaptive media device control operations.

In order to facilitate the media optimization operations of the server 102, the memory 108 may further comprise a recorder interface module 110, a database interface module 112, a media processing module 114, and a template database 116.

The media device interface module 110 controls various operations of the adaptive media device 104, such as controlling the location, focus, and direction of the adaptive media device 104, one or more on-screen prompts displayed on the adaptive media device 104, user positioning cues provided by the adaptive media device 104, and the like. In some aspects, the media device interface module 110 accesses data stored within the template database 116 to determine the control of the adaptive media device 104. In some aspects, the adaptive media device 104 is controlled by sending one or more control signals to the adaptive media device 104 via a connection to the adaptive media device 104, such as by a wired or wireless network, a universal serial bus (USB) cable, a coaxial cable, a FIREWIRE cable, Infrared signaling, BLUETOOTH, storage on removable media, or any other method of communicating among electronic devices.

The media device interface module 110 may further provide an interface for system level software executing on the server 102. For example, the media device interface module 110 may provide an application programming interface (API) to provide an interface for other software modules to communicate with the adaptive media device 104. In some aspects, the media device interface module 110 may provide a device driver interface for the adaptive media device 104.

In some aspects, the media device interface module 110 may also provide a graphical user interface (GUI) for configuration of the adaptive media device 104. For example, the media device interface module 110 may allow a user to select a video template from the template database 116, where the video template corresponds to a particular video clip. The media device interface module 110 may further allow for configuration of various parameters associated with a video capture operation, such as gender, age, size, wardrobe, makeup instructions, and the like. In some aspects, the media device interface module 110 may configure one or more of the parameters based on sensor input, such as from the adaptive media device 104. For example, an actor may be equipped with a radio frequency identifier (RFID) tag, used to associate the particular actor with a set of configuration options. Upon receiving a signal from the RFID tag, the media device interface module 110 may configure the parameters based on the particular parameters (e.g. user name, height, weight, gender, etc.) associated with the RFID tag.

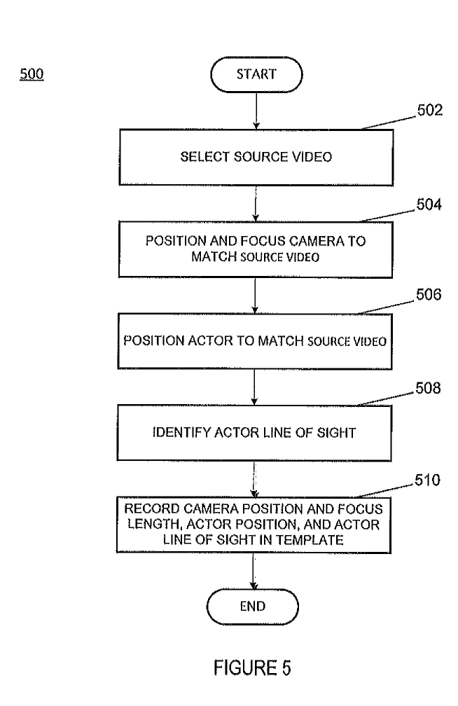

The memory 106 may further store a database interface module 112. The database interface module 112 provides for access, modification, and configuration of data stored within the template database 116. For example, the database interface module 112 may provide for the addition, deletion, and/or modification of template files stored in the template database 116. The content and structure of the template database 116 is described further below and with respect to FIG. 5.

The media processing module 114 provides for media capture, processing, and encoding operations. In some aspects, the server 102 receives a video stream from the adaptive media device 104, which the media processing module 114 then encodes. In some aspects, the media processing module 114 is configured to combine the video stream with another set of video data, such as to produce a single output video. In some aspects, the media processing module 114 applies various post-processing effects to the output video in order to make the output video appear as if it was generated from a single video stream. In some aspects, the media processing module 114 operates to eliminate a “green screen” or “blue screen” from the video stream to color-key out a background in order to support the insertion or layering of actors, props, sets and existing media to assemble artistically desirable output videos. In some aspects, the media processing module 114 may interface with a template associated with a particular source video to facilitate the combination of a video stream received from the adaptive media device 104 with the particular source video to create a single output video containing both the video stream and the particular source video.

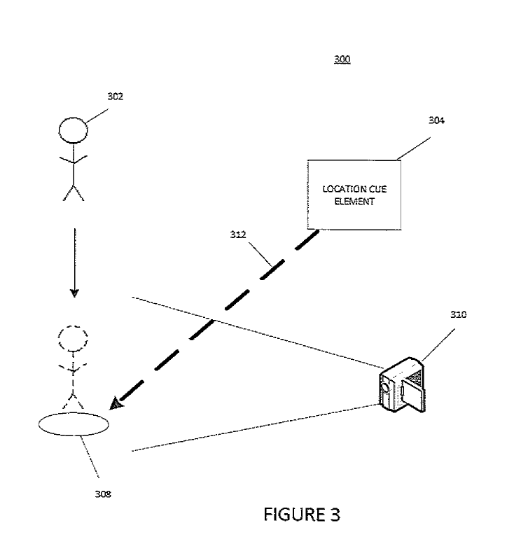

The template database 116 comprises one or more templates associated with one or more source video clips. Each template contains a set of data that may be used to control the adaptive media device 104 to accurately capture a video stream for combination with the source video clip to which the template is associated. For example, a template may include a set of instructions to control the location of the adaptive media device 104 at a particular time (see FIG. 2), a set of lines and director instructions for display on the adaptive media device (see FIG. 2), and a set of prompts and/or cues for instruction of the actor (See FIG. 3). The construction and structure of a video template and the video template database are described further with respect to FIG. 5.

The adaptive media device 104 operates to facilitate the capture of video in accordance with a set of instructions, such as the instructions contained within the template database and received from the server 102 via the media device interface module 110. The adaptive media device 104 provides a variety of features to assist in the capture of aesthetically pleasing video based on the instructions. In some aspects, the adaptive media system operates in a “green screen” studio where every location in the studio is represented by a Cartesian coordinate system that is scalable to the level of accuracy necessary for the application. Every location in the “real space” studio may have an equivalent location in a “virtual studio” so that content and environment choices in each space can accurately coincide and match seamlessly.

The adaptive media system may provide for a system by which a particular actor in a scene is analyzed by automated methods, manual methods or a combination thereof to create a set of instructions that position the actors eye gaze by positioning their lines in a location that matches where they should be looking and by moving those lines depicted in a typewritten or graphic form for “coaching” purposes. For example, based on the scene, the adaptive media device may indicate—“Get ready to scream in 10 seconds” and then a 10 second count down appears.

The adaptive media system may be mapped and positioned manually by a technician to properly position the actor's eye gaze or through automated eye gaze tracking to populate the system database with the Cartesian coordinates that indicate where the actors lines and the actors gaze need to be for precise alignment within each frame of the recording. Facial recognition software may be used to quickly identify the frames occupied by a particular actor. These frames are commonly identified by a time code. The same time code may be used by the adaptive media system as a unique identifier of each frame.

The adaptive media system may utilize a robotically controlled monitor, projector or multiple projectors mounted above the actors projecting their lines onto a surface at enough of a distance to get the desired accuracy of eye gaze. When the correct eye gaze requires the actor to look directly into the camera the actors lines shift on to a traditional beam splitter arrangement with the camera shooting through the one-way glass.

In particular, the adaptive media device 104 may include a device positioning element 118, a display element 120, a location cue element 122, and a video capture element 124. Although the adaptive media device 104 is generally described as a single element, the adaptive media device 104 could also be implemented as a set of elements in communication with one another, such as a robotic arm for movement of a camera, a projection screen for display of instructions and prompts, a projector for displaying content on the projection screen, and the like.

The device positioning element 118 comprises a means to move the adaptive media device 104 in order to facilitate video capturing operations. For example, the adaptive media device 104 may be mounted upon a robotic arm capable of moving the device 104 in a three-dimensional space, the adaptive media device 104 may be stationary with a movable camera and display projection system, the adaptive media device 104 may be mounted upon a multi-directional platform capable of moving on two or more axes, or the like.

In some aspects, the device positioning element 118 may further comprise a processor operationally coupled to a template database, a memory, and a communications interface, such as the template database 116, and the memory 108 described above with respect to the server 102. In some aspects, the device positioning element 118 may comprise a separate processor and memory for performing these functions in communication with the server 102. The memory may store instructions generated from a video template, causing the device positioning element 118 to control the movement of a visual display that moves or stays stationary to properly position an actor's head position, gaze and eye lines as defined by the interactive blue/green-screen virtual requirements of the scene as specified within the video template.

In some aspects, the device positioning element 118 further comprises an interface for manual control, such as for fine tuning of the device location. For example, the device positioning element 118 may include a joystick, mouse, or other means for manual control that allows a director to position aspects of the adaptive media device 104.

The adaptive media device 104 further comprises a display element 120. The display element 120 operates to display one or more instructions or prompts to an actor in accordance with instructions received from the server 102. The display element 120 may comprise a monitor that moves on a robotic arm or a projector, such as a robotic arm or projector as controlled by the positioning element 118. The projector may project the actor's lines onto or through a surface in a studio visible to the actor. The display element 120 may support multiple monitors and/or projectors functioning in parallel to support multiple actors. Aspects of the display element 120 may support infrared and laser sensing devices tied to instructions as provided by a video template, such as stored within the template database 116. Aspects of the display element 120 are further described below with respect to FIG. 2.

The adaptive media device 104 further comprises a location cue element 122. The location cue element 122 provides one or more prompts or cues to an actor to indicate proper placement within a video scene, such as associated with a video template stored within the template database 116. For example, the location cue element 122 may utilize projected laser light or other focused light aimed at a studio floor or other surfaces. The light cues may emanate from either above or below the studio floor. Lights such as LEDs embedded below or in the floor or props may also be utilized. In some aspects, a laser cue element may be mounted upon a robotic arm as controlled by the positioning element 118. The laser cue element may point to a particular location on the studio floor and display an indicator for the actor to stand at the particular location place during capture of a scene. As with the display element 120 and the positioning element 118, the location cue element 122 operates in conjunction with instructions received from the video template, including indicating particular locations at particular times, to facilitate the combination of the captured video with a source video.

The adaptive media device 104 further comprises a video capture element 124. For example, the video capture element 124 may comprise a studio video camera, a digital camcorder, a webcam, or any other device operable to capture a video image. Although aspects of the invention are primarily described with respect to digital video capture, the video capture element 124 might also comprise various analog video capture methods, such as video tape, film, or the like. Such analog capture mechanisms may include further intermediate processing elements to perform an analog to digital conversion for combining a captured video stream with a source video.

In some aspects, the video capture element 124 is mounted on an aspect of the positioning element 118, such as on a robotic arm or moving platform. In this manner the positioning element 118 may control the placement, direction, and/or focal features of the video capture element 124. For example, the positioning element 118 may point the video capture element 124 to a particular part of the studio in which an actor should be standing as instructed by a video template. In some aspects, sensor data is provided by the video capture element 124 to configure the scene. For example, scene lighting may be automatically adjusted based on current lighting conditions as observed by the video capture element 124 compared to lighting conditions specified in the video template, or the device positioning element 118 may adjust the camera position depending upon the position of an actor as observed by the video capture element 124.

FIG. 2 illustrates a display 200 for providing instruction via an adaptive media device in accordance with aspects of the invention. The display 200 comprises a view screen 202 that is operable to move along multiple axes, such as the x-axis 206 and the y-axis 204. Movement of the display 200 may be enabled by the positioning element 118 described above with respect to FIG. 1. For example, the display 200 may be mounted on a robotic arm or projected onto a surface using a movable projector. Although two axes 204 and 206 are shown, the display 200 may also be operable to move along a third axis, such as a z-axis (not shown), to facilitate positioning of the display 200.

The view screen 202 comprises a video content display 208, a line-of-sight indicator 210, one or more lines 212, and one or more directions 214. The video content display 208 may display an original version of a video clip that the actor is to emulate. The actor may then use the video content display 208 to properly act out the video scene. The line-of-sight indicator 210 is positioned such that when the actor gazes towards the light-of-sight indicator 210, the actor's gaze recreates the conditions of the source video.

The line 212 instructs the actor to say a particular line from the source video scene. In this manner, the display functions as a teleprompter, showing the actor which lines to say at which particular times. The direction 214 instructs the actor to perform a particular act. For example, the direction 214 might read “Turn to your right and look behind you.” The line 212, the direction 214, the video content display 208, and the movement of the view screen 200 are controlled by data entries within a particular video template. The video template is associated with a particular video clip. The instructions provided by the video template allow for recreation of the conditions of the particular video clip such that a video captured by the adaptive media system may be combined with the particular media clip to create a single output video in a seamless manner.

FIG. 3 illustrates the operation of a system for indicating a placement cue using an adaptive media device in accordance with aspects of the invention. The system comprises a location cue element 304, such as the location cue element 122 described with respect to FIG. 1, and a video capture element 310, such as the video capture element 124 described with respect to FIG. 1. The system directs an actor 302 to stand, sit, lay down, or the like at a particular location 308 in accordance with instructions received from a video template. The diagram depicts an actor 302 at a first location, with an indicator 312 from the location cue element 304 instructing the actor to move to a location 308, such that the actor is standing in view of the video capture element 310. For example, the location cue element 304 may control indicators that place the actor's feet in the correct location relative to the camera and props and in the correct body orientation to fit correctly in the existing content clip. Examples of these indicators may include monitors, projectors, infrared devices, laser pointers, LEDs under the studio floor, and the like to guide the actor into position.

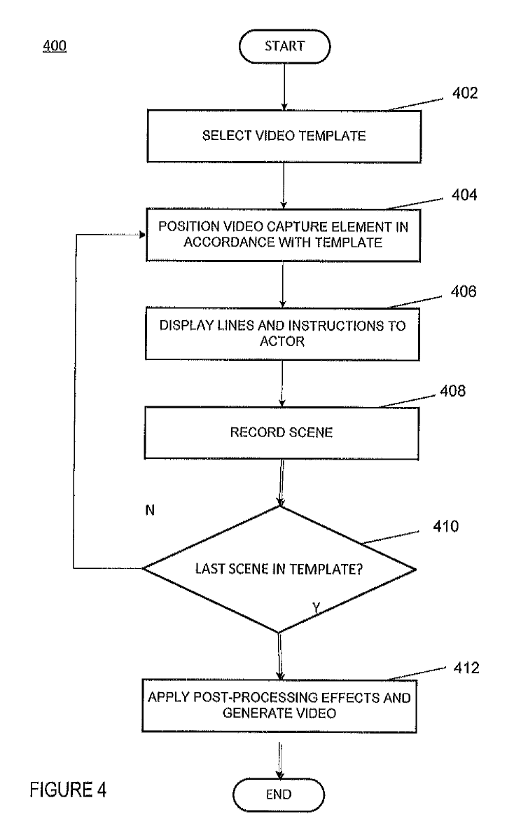

FIG. 4 illustrates a method 400 for providing an adaptive interactive media experience in accordance with aspects of the invention. The method 400 allows for the selection of a video template which is then used to instruct the adaptive media system in the process of capturing a video to be combined with into a source video associated with the video template. The video template may be selected from a plurality of video templates stored in a database, such as the template database 116 described with respect to FIG. 1. The video template configures the adaptive media system to capture a video that may be seamlessly combined with the source video by positioning a video capture element and prompting an actor in accordance with cues extracted from the original source video.

At block 402, a video template is selected. The selection may be from a plurality of video templates, each template associated with one or more source videos. The video template comprises instructions for the adaptive media system that may be used to ensure seamless combination with a source video. For example, the video template may include scene timings, actor direction prompts, script lines, camera movement instructions, and the like. The structure and generation of a video template is described further with respect to FIG. 5.

At block 404, a video capture element is positioned in accordance with the template. The video capture element may be positioned as such in order to recreate a camera angle of the source video. In this manner, video captured with the camera positioned as such may be seamlessly combined with a source video so as to appear as if the newly captured video was present in the original source video. The video capture element may be positioned via a video positioning element as described with respect to FIG. 1. In some aspects, the video capture element is located on a moving platform or robotic arm, controlled by instructions received by a server processing the video template.

At block 406, lines and/or instructions associated with the video template are displayed to the actor. For example, the video template may call for an actor to say a certain line and perform a certain action at a certain time. These instructions may be displayed upon a display element so the actor can read and react appropriately. In some aspects, the instructions are further displayed in a particular location such that the actor's line-of-sight when reading the instructions emulates the line of site of an actor in the original source video. The instructions may also include one or more position cues, such as provided by a positioning element and described with respect to FIG. 3.

At block 408, a video capture element records the scene in accordance with the template. An individual scene may include multiple camera movements, position cues, line displays, actor prompts, and the like. Each of these various instruction elements are processed and displayed/executed as appropriate in accordance with the video template.

At block 410, a determination is made as to whether the scene recorded at block 408 is the final scene in the video template. A particular template may include one or more scenes. If the scene shot at block 408 is the only scene in the template or the final scene in the template, the method 400 proceeds to block 414. Otherwise the method 400 returns to block 404 to shoot the next scene.

At block 414, post-processing effects are applied to the video as specified by the video template. These post-processing effects may include the addition of various screen filters, special effects, and editing techniques to incorporate the captured video with a source video. For example, the post-processing effects may include blue/green screen color extraction to layer the captured video into a sourced video. After the captured video is integrated with the source video, an output video is generated. In some aspects, the output video is provided on a removable storage medium, such as a flash drive, a digital video disc, a compact disc, or the like. In some aspects, the output video is saved as a video file and provided via e-mail or cloud storage.

FIG. 5 illustrates a method 500 for generating a video template for use in an adaptive interactive media system in accordance with aspects of the invention. The method 500 operates to use a source video to generate a video template which includes instructions for recreating elements of the source video, such that the video template may be used to configure an adaptive media system to emulate the source video. The video template may then be used to capture a video to be integrated into the source video, providing a single output video. In some aspects, a technician may position the actor on set with the actor wearing a laser pointer and modified GPS style tracking device that feeds data into the RP for the projection and establishment of a grid that corresponds to the “real space” Cartesian coordinates. The location of the eye gaze can be input into the database manually or through the RP tracking system component that coordinates correct eye gaze with each frame of the scene.

The video template may include instructions to display information (e.g., script lines or stage instructions) to a user and to direct the user. For example, the video template may include the lines the user is to read during the scene, the stage instructions to be displayed to the user, and instructions for positioning the display element and the camera and for providing location cues to the user. The video template may be associated with a particular video or videos. For example, each video into which the user may be inserted may have a unique template, or a particular template may correspond to multiple source videos. It should be understood that the video template may be provided with the source video as a single data object, or the video template may be separate from the source video itself.

At block 502, a source video is selected. The source video is associated with the generated video template, as the video template is designed to recreate video capture characteristics of the source video. For example, the source video may be a particular scene from a popular action movie. The generated video template would allow an actor to insert themselves in the position of the main character in the scene.

At block 504, the position and focus of a video capture element are configured to match the conditions of the source video. For example, a camera position and focal length may be configured manually to match the scene, or the positioning may occur in an automated manner using an actor, technician, and/or robot to calibrate the camera settings as compared to the source video.

At block 506, the actor, technician, or robot is positioned to match the source video. For example, a stand-in actor or automated robot may be positioned on a green screen/color-keyed stage to isolate the actor and props from the background and to allow the insertion of the actor and props into an existing scene through a computerized matting process.

At block 508, the line-of-sight of the actor, technician, or robot is recorded as they emulate an actor within the source video. For example, the line-of-sight may be recorded by monitoring a laser pointer mounted on a robot eye or on a set of glasses worn by an actor. In some aspects, a technician uses a joystick to manually position a mark on a wall. When the Actor/Robot head & eyes are correctly positioned in accordance with the source video, the position of the mark is recorded.

At block 510, the scene characteristics as determined at blocks 504 through 508 are recorded in a video template. In some aspects, such as when a scene has multiple camera cuts, the video template will have multiple entries. For example, a video template may have an entry for each separate camera angle in a scene, for each line in a scene, for particular special effects in a scene, or for each action in a scene. In some aspects, a template generated by the above method might take the form:

TABLE 1

| | Eye line | | Camera: Height, | | |
|---|---|---|---|---|---|
| | (x, y, z | Shoulder | focal length, | | |
| Time | coordinates) | heights | aperture | Lights | Effects |
| :00-:16 | 7, 8, 5 | −5.−5.10 | 5′, 50 mm, | Dim, | N/A |
| | | | f/4 | flat | |
| :16-:23 | Off camera | −5.−5.10 | 5′, 50 mm, | Dim, | N/A |
| | | | f/4 | flat | |
| :23-:32 | 7, 8, 5 | −5.−5.10 | 5′, 50 mm, | Dim, | N/A |
| | | | f/4 | flat | |
| :32-:46 | −5.−5.10 | 10, 10, 8 | 5′, 50 mm, | Dim, | Gun |
| | | | f/4 | flat | loading |
| | | | | | SFX |
| :46-:52 | 7, 8, 5 | −5.−5.10 | 5′, 50 mm, | Dim, | N/A |
| | | | f/4 | flat | |

After generating the video template, the method 500 ends.

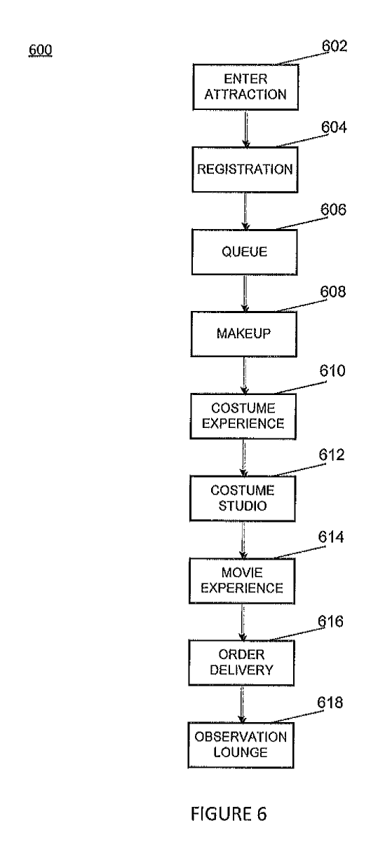

FIG. 6 illustrates a studio workflow 600 in accordance with aspects of the invention. The studio workflow 600 represents a possible user experience for a user engaged in an adaptive media experience as provided by the adaptive media system. The workflow 600 illustrates the process by which a user engages in an adaptive media experience from initial entry to an attraction through completion of a video shoot and on to an observation lounge.

The user first enters the attraction at block 602. The attraction entry may be characterized by video displays showing exemplary videos prepared by the adaptive media system. The video displays may also explain the steps in the process for users of the adaptive media system. The users may be greeted by costumed “Stars” of major movies. The users may also be presented with an instructive video that takes an ‘ideal customer’ through each block of the adaptive media experience. The attraction entry may include an area where guests can meet visiting stars.

In some aspects, the attraction entry includes one or more data gathering systems, such as a system to identify the clips or part of the presentation that holds the customer interest the longest—dwell time, a system for customers to request clips they would like to be in and a system to contact them when that clip is available, or a system to allow the insertion of special ads based on park events, corporate parties, B Day parties etc. In some aspects, the square feet/meters allocated for attraction entry are based on overall design dimensions

After passing through the attraction entry 602, the user arrives at a registration area at block 604. In the registration area, the user selects various aspects of their media experience, such as which source video clip to use, whether to include costuming and makeup, and the like. The registration area may further include one or more order entry kiosks. The order entry kiosks may allow for direct customer order entry, such as via a touch screen. The kiosks may further include a management system to override, change etc. located at a manned customer service area. The registration area may include group scheduling operations. For example, the registration area may include special advertisements tailored to a particular scheduled group, special merchandise or identifying information provided on completed videos, and the like.

The registration area may include features that allow for tracking of inventory for reorders, source video usage for license fees and to identify and replace less popular source videos. Aspects of the order system provided by the order entry kiosks may include allowing direct customer entry for purchase of clips and merchandise, the ability to handle multiple orders so one person can pay for multiple family members, event attendees, or birthday party guests, and discounts for multiple purchases on the same order.

The order entry kiosks may also allow payment via ATM, Credit or debit card systems. In some aspects, the registration process produces an identifier for the user, such as an RFID tag, a Quick Response (QR) code, a bar code, or the like to track customers, work flow, and product delivery. The order system may display to the user a pre-determined number of source videos, each with encapsulated versions of scenes related to the experience. The films may be separated into categories such as comedy, action, drama, or based on particular movie stars or characters from the film. In some aspects, the order kiosks also present a language selection option.

During the order process, the user may be prompted for a number of configuration options. These options may include the selection of the source video, whether the user wishes to be costumed for the scene, the delivery media (e.g. DVD, flash drive, or e-mail), or whether the user wishes to purchase a branded promotional item (e.g. shirts, hats, mugs, etc.).

After completing the order process, the user may receive a bar code or RFID tag sales order receipt that initiate the media experience production protocol. The receipt structure may be provided in the same manner as other receipts issued at the same location, such as at a theme park. The user may also be provided with a plastic laminate on a lanyard that identifies the participant as a “Star”. The customers may be continuously tracked at each step of the process for efficiency metrics, such as to identify bottlenecks in the process, allow refinement of the system, allow staffing adjustments for slower times, or to identify a dwell time at each stage for system assessment.

The registration area may further include an attended sales counter for questions and order processing for customers who prefer not to use an ordering kiosk.

After placing an order during the registration process, the user may wait in a queue at block 606. The sales order generated at block 604 may directs the user into a particular studio queue. For example, there may be multiple studios in operation, each shooting a particular source video. The queue area may incorporate colored, numbered, or themed queue areas based on high-traffic featured movies with design elements to speed users through the process. These queues may include turnstiles operated by RFID/QR code entry, different queues for face-only users and costumed users, and the like. Monitors along the queue may define and reinforce the procedure in an entertaining, informative way. These monitors may also provide acting tips. These tips may include showing a video wherein the Actor that the user is replacing is isolated from the scene so the user can review the scene. In this manner, the user may be shown what to do during the scene without the distraction of watching the entire scene while practicing. This may also provide an opportunity to practice lines while waiting in the queue. Family and friends may be permitted to accompany the user for support. The user may also be presented with an opportunity to purchase costume items during the queue process.

At block 608, the user may be provided with makeup options. For example, after exiting the queue from block 606, the user may enter a makeup room where they are provided with various makeup options associated with the source video they selected.

At block 610, the user is provided with a set of costuming options dependent upon the selection made during the ordering process. For example, a “face-only” selection might be provided with fewer costuming options than a “full costume” selection. Costuming options may be provided based on the size of the user, such as small, medium, large, x-large, etc. Hygiene concerns may be obviated through the use of theatrical breakaway paper. The costuming process may be structured such that a particular costume associated with the user's chosen source video is waiting for the user upon arrival to the costume area. Superior costumes may be offered for sale at an additional cost.

After exiting the costuming area from block 610, the user may enter a costume studio at block 612. In the costume studio, the user may be presented with a final opportunity to review their costume. A monitor at the entry may confirm the user's costume choices and repeat procedure and tips just prior to studio entry. The user may be presented with final confirmation prompts that their order is correct. The user may be further “sized” to match chosen scene, such as by an automated process involving a photograph sizing technique.

At block 614, the user enters a studio to take part in the adaptive media experience as described above with respect to FIGS. 2-4. The studio may comprise a backlit green screen for lighting adjustments over a wide range of scenes. The studio may include an audible or visual warning system for control room to improve the studio takes and/or to identify scene for additional edit. In some aspects, the studio may include lit or projected footsteps or action marks on the floor to direct the user in their performance. In some aspects, the projected footsteps or action marks are provided by a location cue element as described above with respect to FIG. 3. The adaptive media system described above with respect to FIGS. 1-4 may provide automated film production and alignment integration, such as by conforming to height of customer, the viewpoint of scene, and the like.

After completing the adaptive media experience, the user may have their completed video delivered at block 616. As described above, the video may be provided on a non-transitory computer readable medium, via e-mail, cloud storage, or the like. The video is a seamlessly combined composite of the source video selected during the registration process and the video shot in the studio as described with respect to block 614. The user may also be presented with the opportunity to purchase ancillary products, such as hats, t-shirts, additional copies of the movie, and the like during the order delivery process.

After receiving the completed video, the user may enter an observation lounge at block 618. Here the user may observe other users shooting their video. The workflow ends as the user exits the observation lounge.

The systems and methods described herein advantageously provide for a flexible and robust method, system, and apparatus for providing an adaptive media experience. The method, system, and apparatus allow for capture and compositing operations to be performed in accordance with a defined video template such that a user is provided with a seamlessly integrated output video, including their performance in a studio environment. By providing for a camera positioning system, a location cue element, and a display element incorporated with a camera system, aspects of the invention allow for efficient instruction and prompting operations of a user without the need for external direction, cue cards, or other separate devices.

As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible embodiments.

1. A computer-implemented method for providing an adaptive media experience to a user, the method comprising:
providing a video template;
operating an adaptive media device to display information to the user on a display in accordance with the video template, the display located at a first location specified in the video template such that the user is positioned in a first desired position;
further operating the adaptive media device to position the display at a second location such that the user is positioned in a second desired position;
operating a video capture element to capture video of the user at at least one of the first desired position or the second desired position; and
integrating the captured video into at least a portion of a preexisting video to create a composite video.

2. The method of claim 1, wherein the information comprises at least one of a script line or a stage direction to instruct the user.

3. The method of claim 1, wherein the display is positioned using a robotic arm.

4. The method of claim 1, wherein the preexisting video is associated with the video template.

5. The method of claim 1, further comprising projecting a position cue to notify the user to stand in at least one of the first desired position or the second desired position.

6. The method of claim 1, further comprising configuring the video capture element using the video template.

7. The method of claim 6, wherein the configuration of the video capture element includes at least one of a pan, tilt, or zoom setting of the video capture element or adjusting a focus setting of the video capture element.

8. The method of claim 1, wherein the positioning the user at the first desired position includes displaying the information in a physical location to direct the user to look in the first desired position.

9. The method of claim 1, wherein:
the video template comprises timing instructions and control instructions keyed to the timing instructions; and
the adaptive media device is positioned using the control instructions in accordance with the timing instructions.

10. An adaptive media device comprising:
a display element for displaying information to a user of the adaptive media device, the display element movable to at least two locations in accordance with a video template, such that the at least two locations direct a position of the user during a video capture operation; and
a video capture element for performing the video capture operation.

11. The adaptive media device of claim 10, further comprising a positioning element for moving the display element in accordance with the video template.

12. The adaptive media device of claim 11, wherein the positioning element is a robotic arm and wherein the video template comprises instructions for moving the robotic arm.

13. The adaptive media device of claim 10, further comprising a location cue element for indicating a position of an actor in accordance with the video template.

14. The adaptive media device of claim 10, wherein:
the location cue element further comprises a projector; and
the location cue element indicates the position of the actor by projecting an image at the position.

15. The adaptive media device of claim 10, wherein the display element is moved to one of the at least two locations, the information is displayed such that the user is looking in a particular direction.

16. The adaptive media device of claim 10, wherein the information is at least one of a script line or a stage direction.

17. The adaptive media device of claim 16, wherein the display element is configured such that the one or more script lines or direction prompts are only visible when the actor is standing at the position indicated by the location cue element.

18. The adaptive media device of claim 10, wherein the video template comprises timing instructions and control instructions keyed to the timing instructions; and
the display element is positioned using the control instructions at one or more times indicated by the timing instructions.

19. The adaptive media device of claim 18, wherein the control instructions further comprise one or more location cues and one or more camera configuration instructions.

20. A video system for providing a composite video, the system comprising:
a memory for storing a video template comprising one or more instructions for displaying information to a user;
an adaptive media device for displaying information to a user of the system in accordance with the video template, the adaptive media device movable to at least two locations in accordance to the video template, the at least two locations directing the user to at least one of a first position or a second position, respectively;
a video capture element for capturing video of the user at at least one of the first position or the second position.
